(19) United States
(12) Patent Application Publication
(10) Pub. No.: US 2016/0078206 A1
(43) Pub. Date: Mar. 17, 2016

(54) TERMINAL DEVICE AND METHOD FOR CONTROLLING ACCESS TO SAME

(71) Applicant: Chiun Mai Communication Systems, Inc., New Taipei (TW)

(72) Inventors: HOW-WEN CHIEN, New Taipei (TW); CHUANG-WEI CHUEH, New Taipei (TW)

(73) Assignee: CHIUN MAI COMMUNICATION SYSTEMS, INC., New Taipei (TW)

(21) Appl. No.: 14/825,319

(22) Filed: Aug. 13, 2015

(30) Foreign Application Priority Data
Sep. 16, 2014 (CN) 201410472980.5

(51) Int. Cl. G06F 21/31

(52) U.S. Cl. CPC G06F 21/31

(57) ABSTRACT

A method for controlling access to a terminal device includes collecting light signals emitted by a lighting device of an electronic device. The light signals is converted to digital signals. Once the digital signals match a preset password of the electronic lock, the electronic lock is controlled to unlock the terminal device.

### CROSS-REFERENCE TO RELATED APPLICATIONS

This application claims priority to Chinese Patent Application No. 201410472980.5 filed on Sep. 16, 2014, the contents of which are incorporated by reference herein.

### FIELD

The subject matter herein generally relates to access control technology, and particularly to a terminal device and a method for controlling access to the terminal device.

### BACKGROUND

A terminal device (e.g., a personal computer, a safe deposit box, for example) may need to be locked to keep the terminal device safe. Usually, the locked terminal device can be unlocked using a password. It is important that the password must be not easily to be cracked.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a terminal device.

FIG. 2 is a block diagram of one embodiment of function modules of an unlocking system included in the terminal device of FIG. 1.

FIG. 3 illustrates a flowchart of one embodiment of a method for setting a password of the terminal device of FIG. 1.

FIG. 4 illustrates a flowchart of one embodiment of a method for unlocking the terminal device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

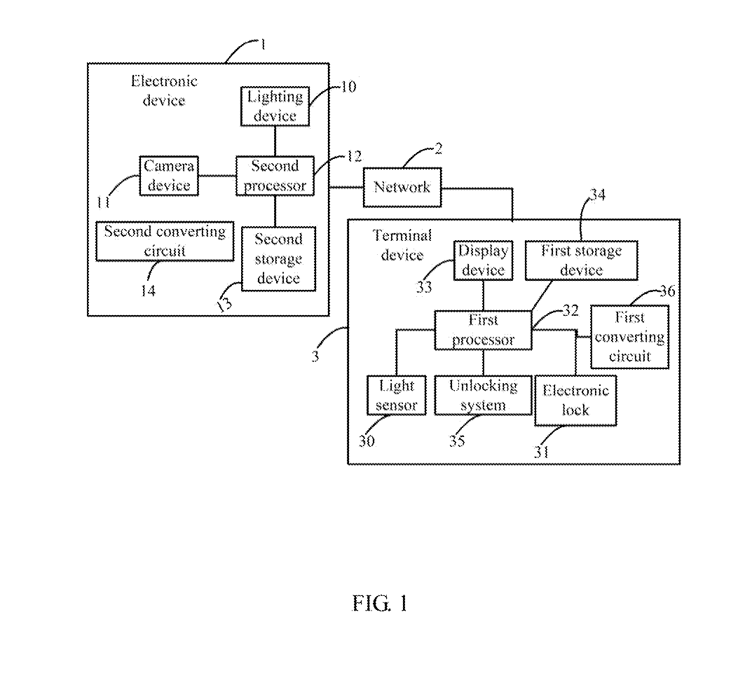

FIG. 1 is a block diagram of one embodiment of a terminal device. The terminal device may be a security door, a safe deposit box, a computer, a motor vehicle, or any other suitable device such as a rickshaw. Depending on the embodiment, a terminal device 3 includes a light sensor 30, an electronic lock 31, a first processor 32, a display device 33, a first storage device 34, an unlocking system 35, and a first converting circuit 36. FIG. 1 illustrates only one example of the terminal device 3. One skilled in the art may know that the terminal device 3 may include more or fewer components than illustrated, or have a different configuration of the various components in other embodiments.

The terminal device 3 can communicate with an electronic device 1 through a network 2. The terminal device 3 can receive light signals transmitted from a lighting device 10 of the electronic device 1. The network 2 can be a mobile network, public telephone network, the Internet or any other suitable network type such as a local area network.

The electronic device 1 can be a smart phone, a tablet computer, or any other suitable device such as a wearable device. The lighting device 10 can be internally configured in the electronic device 1. The lighting device 10 can be a light emitting diode (LED).

The electronic lock 31 can be used to lock the terminal device 3. The light sensor 30 can be used to collect light signals transmitted by the lighting device 10 of the electronic device 1. The first converting circuit 36 provides functions of an analog-to-digital (A/D) conversion and a digital-to-analog (D/A) conversion. In the present embodiment, the first converting circuit 36 can convert the light signals collected by the light sensor 30 to digital signals.

The unlocking system 35 can control the electronic lock 31 to unlock the terminal device 3 according to the light signals transmitted by the lighting device 10 of the electronic device 1.

The display device 33 can be a touch screen, and can be used to output visible information. For example, the display device 33 can output a prompt message that the terminal device 3 is successfully or unsuccessfully unlocked.

The first storage device 34 can be an internal storage device, such as a flash memory, a random access memory (RAM) for temporary storage of information, and/or a read-only memory (ROM) for permanent storage of information. The first storage device 34 can also be an external storage device, such as an external hard disk, a storage card, or a data storage medium.

The first processor 32 can be a central processing unit (CPU), a microprocessor, or other data processor chip that performs functions of the terminal device 3.

The electronic device 1 further includes a camera device 11, a second processor 12, a second converting circuit 14, and a second storage device 13. FIG. 1 illustrates only one example of the electronic device 1. One skilled in the art may know that the electronic device 1 may include more or fewer components than illustrated, or have a different configuration of the various components in other embodiments.

The camera device 11 can be used to capture images. In the present embodiment, the camera device 11 can capture an image of a two-dimensional barcode representing a password of the electronic lock 31 of the terminal device 3.

The second converting circuit 14 can provide functions of the A/D conversion and the D/A conversion for the electronic device 1. In the present application, the second converting circuit 14 can convert the password of the electronic lock 31 to analog signals.

The second storage device 13 can be the internal storage device, such as the flash memory, the random access memory (RAM) for temporary storage of information, and/or the read-only memory (ROM) for permanent storage of information. The second storage device 13 can also be the external storage device, such as the external hard disk, the storage card, or the data storage medium.

The second processor 12 can be the central processing unit (CPU), the microprocessor, or other data processor chip that performs functions of the electronic device 1.

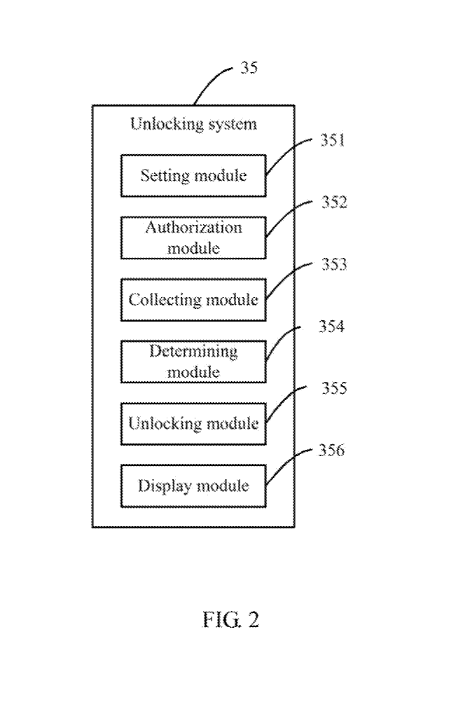

FIG. 2 is a block diagram of one embodiment of function modules of the unlocking system. In at least one embodiment, the unlocking system 35 may include a setting module 351, an authorization module 352, a collecting module 353, a determining module 354, an unlocking module 355, and a display module 356. The function modules 351-356 may include computerized codes in the form of one or more programs, which are stored in the first storage device 34, and are executed by the first processor 32 of the terminal device 3 to provide functions of unlocking the electronic lock 31, according to the light signals received from the electronic device 1. Details will be given in the following paragraphs.

The setting module 351 can preset a password of the electronic lock 31 of the terminal device 3 according to user requirement. In one embodiment, the password of the electronic lock 31 can be binary data that is composed of “0” and/or “1”. The setting module 351 can convert the password of the electronic lock 31 to a two-dimensional barcode image using the first converting circuit 36. The setting module 351 can store the two-dimensional barcode image in the first storage device 34 of the terminal device 3.

The setting module 351 can receive the input of an identification code of the electronic device 1 and store the identification code of the electronic device 1 in the first storage device 34. In one embodiment, the identification code is a mobile equipment identifier (MEID) of the electronic devices 1. In one embodiment, the identification code of the electronic device 1 is stored in the first storage device 34 in binary format. That is, the identification code of the electronic device 1 stored in the first storage device 34 is composed of “0” and/or “1”

The authorization module 352 can send the two-dimensional barcode image (i.e., the password of the electronic lock 31) to the electronic device 1 through the network 2 to authorize the electronic device 1 to access the terminal device 3. Alternatively, the authorization module 352 can control the display device 33 to display the two-dimensional barcode image so that the camera device 11 of the electronic device 1 can capture the two-dimensional barcode image.

In one embodiment, the setting module 351 can further preset a number of times and an expiration date that the electronic device 1 can access the terminal device 3. For example, the setting module 351 may preset that the electronic device 1 can access the terminal device 3 for three times before Jan. 1, 2016.

Similar to above method, the setting module 351 can further receive the input of an identification code of each of one or more other electronic devices including a lighting device. The setting module 351 can further store the identification code of each of the one or more other electronic devices in the first storage device 34. The authorization module 352 can send the two-dimensional barcode image to each of the one or more other electronic devices to authorize the each of the one or more other electronic device to access the terminal device 3.

The second processor 12 of the electronic device 1 can control the lighting device 10 of the electronic device 1 to emit light signals representing the identification code of the electronic device 1. In one embodiment, the lighting signals can be composed of one or more bright signals and one or more dark signals. In one embodiment, a bright signal can be defined to be a light signal whose brightness value is greater than a preset value. A dark signal can be defined to be a light signal whose brightness value is less than or equal to the pre-set value. In one embodiment, the bright signal represents a numeral “1”, and the dark signal represents a numeral “0”. For example, when the identification code of the electronic device 1 is “0011”, the second processor 12 of the electronic device 1 controls the lighting device 10 to sequentially emit a dark signal, a dark signal, a bright signal, and a bright signal.

The collecting module 353 can collect the light signals emitted by the lighting device 10 using the light sensor 30 of the terminal device 3. The collecting module 353 can further convert the light signals to first digital signals using the first converting circuit 36. In one embodiment, the collecting module 353 can convert the bright signal to the numeral “1”, and can convert the dark signal to the numeral “0”.

The determining module 354 can determine whether the first digital signals matches the identification code of the electronic device 1 that is stored in the first storage device 34. When the first digital signals matches the identification code of the electronic device 1, the determining module 354 can determine the electronic device 1 has been authorized to access the terminal device 3. When the first digital signals cannot match the identification code of the electronic device 1, the determining module 354 can determine the electronic device 1 has not been authorized to access the terminal device 3.

In another embodiment, the determining module 354 can further determine whether a number of times that the electronic device 1 has accessed the terminal device 3 are less than the preset number of times, and whether a current date is before the preset expiration date, when determining whether the electronic device 1 has been authorized to access the terminal device 3.

In the present exemplary embodiment, the determining module 354 can determine the number of times that the electronic device 1 has accessed the terminal device 3, by searching a log file. The log file can record related information of the electronic device 1 accessing the terminal device 3. The related information may include, but is not limited to, a date of the electronic device 1 accessing the terminal device 3, and the identification code of the electronic device 1.

When the determining module 354 determines the electronic device 1 has been authorized to access the terminal device 3, the display module 356 can display a first message of informing a user that the electronic device 1 has been authorized to access the terminal device 3 on the display device 33 of the terminal device 3. The determining module 354 further sends the first message to the electronic device 1.

When the determining module 354 determines the electronic device 1 has not been authorized to access the terminal device 3, the display module 356 can display a second message of informing the user that the electronic device 1 has not been authorized to access the terminal device 3 on the display device 33. The determining module 354 further sends the second message to the electronic device 1.

When the electronic device 1 receives the first message, the second processor 12 of the electronic device 1 controls the lighting device 10 to emit light signals representing the password of the electronic lock 31 of the terminal device 3. Similarly to above, the lighting signals can be composed of one or more bright signals and one or more dark signals. The bright signal represents the numeral “1”, and the dark signal represents the numeral “0”.

Similarly to above, the collecting module 353 can collect the light signals emitted by the lighting device 10 using the light sensor 30 of the terminal device 3. The collecting module 353 can further convert the light signals to second digital signals. Similarly to above, the collecting module 353 can convert the bright signal to the numeral “1”, and convert the dark signal to the numeral “0”.

The determining module 354 can determine whether the second digital signals matches the password of the electronic lock 31 that is stored in the first storage device 34.

When the second digital signals can match the password of the electronic lock 31, the unlocking module 355 can control the electronic lock 31 to unlock the terminal device 3. The display module 356 can create the log file to record related information of the electronic device 1 accessing the terminal device 3. As mentioned above, the related information may include, but is not limited to, the date of the electronic device 1 accessing the terminal device 3, and the identification code of the electronic device 1. The display module 356 can further store the log file in the first storage device 34.

When the second digital signals cannot match the password of the electronic lock 31, the display module 356 can display a third message of informing the user that the electronic device 1 accesses the terminal device 3 unsuccessfully.

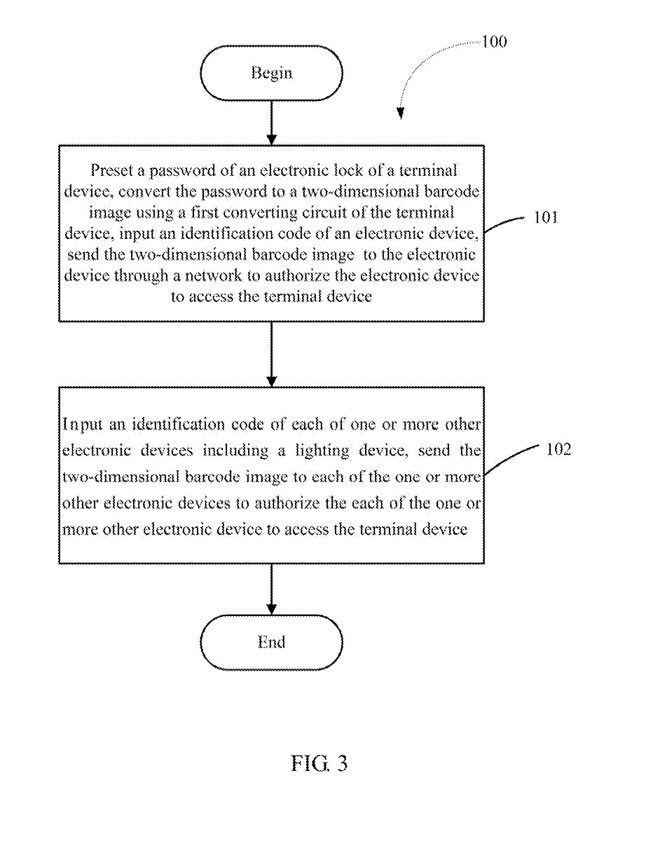

FIG. 3 is a flowchart of an example embodiment of a method for setting a password of an electronic lock of a terminal device. In an example embodiment, the method is performed by execution of computer-readable software program codes or instructions by a first processor of the terminal device.

Referring to FIG. 3, a flowchart is presented in accordance with an example embodiment. The method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 3 represents one or more processes, methods, or subroutines, carried out in the method 100. Furthermore, the illustrated order of blocks is illustrative only and the order of the blocks can be changed. Additional blocks can be added or fewer blocks may be utilized without departing from this disclosure. The method 100 can begin at block 101.

At block 101, a setting module can preset a password of an electronic lock of a terminal device according to user requirement. In one embodiment, the password of the electronic lock can be binary data that is composed of “0” and/or “1”. The setting module can convert the password of the electronic lock to a two-dimensional barcode image using a first converting circuit of the terminal device. The setting module can store the two-dimensional barcode image in a first storage device of the terminal device.

The setting module can receive the input of an identification code of an electronic device and store the identification code of the electronic device in the first storage device. In one embodiment, the identification code is a mobile equipment identifier (MEID) of the electronic devices. In one embodiment, the identification code of the electronic device is stored in the first storage device in binary format. That is, the identification code of the electronic device stored in the first storage device is composed of “0” and/or “1”

An authorization module can further send the two-dimensional barcode image (i.e., the password of the electronic lock) to the electronic device through a network to authorize the electronic device to access the terminal device. Alternatively, the authorization module can control a display device of the terminal device to display the two-dimensional barcode image so that a camera device of the electronic device can capture the two-dimensional barcode image.

In one embodiment, the setting module can further preset a number of times and an expiration date that the electronic device can access the terminal device. For example, the setting module may preset that the electronic device can access the terminal device for three times before Jan. 1, 2016.

At block 102, similar to above method, the setting module can further receive the input of an identification code of each of one or more other electronic devices including a lighting device. The setting module can further store the identification code of each of the one or more other electronic devices in the first storage device. The authorization module can send the two-dimensional barcode image to each of the one or more other electronic devices to authorize the each of the one or more other electronic device to access the terminal device.

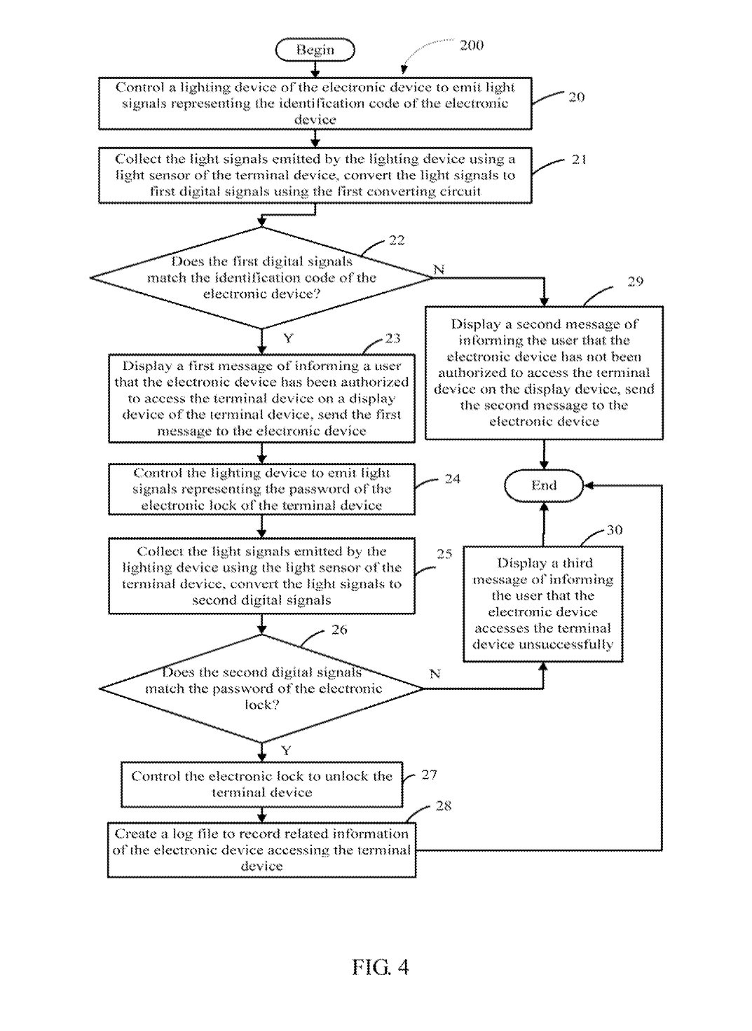

FIG. 4 is a flowchart of an example embodiment of a method for unlocking the terminal device. In an example embodiment, the method is performed by execution of computer-readable software program codes or instructions by the first processor of the terminal device.

Referring to FIG. 4, a flowchart is presented in accordance with an example embodiment. The method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 4 represents one or more processes, methods, or subroutines, carried out in the method 200. Furthermore, the illustrated order of blocks is illustrative only and the order of the blocks can be changed. Additional blocks can be added or fewer blocks may be utilized without departing from this disclosure. The method 200 can begin at block 20.

At block 20, a second processor of the electronic device can control a lighting device of the electronic device to emit light signals representing the identification code of the electronic device. In one embodiment, the lighting signals can be composed of one or more bright signals and one or more dark signals. In one embodiment, a bright signal can be defined to be a light signal whose brightness value is greater than a preset value. A dark signal can be defined to be a light signal whose brightness value is less than or equal to the pre-set value. In one embodiment, the bright signal represents a numeral “1”, and the dark signal represents a numeral “0”. For example, when the identification code of the electronic device is “0011”, the second processor of the electronic device can control the lighting device to sequentially emit a dark signal, a dark signal, a bright signal, and a bright signal.

At block 21, a collecting module can collect the light signals emitted by the lighting device using a light sensor of the terminal device. The collecting module can further convert the light signals to first digital signals using the first converting circuit. In one embodiment, the collecting module can convert the bright signal to the numeral “1”, and can convert the dark signal to the numeral “0”.

At block 22, a determining module can determine whether the first digital signals matches the identification code of the electronic device that is stored in the first storage device.

When the first digital signals matches the identification code of the electronic device, the determining module can determine the electronic device has been authorized to access the terminal device, the process goes to block 23.

When the first digital signals cannot match the identification code of the electronic device, the determining module can determine the electronic device has not been authorized to access the terminal device, the process goes to block 29.

In another embodiment, the determining module can further determine whether a number of times that the electronic device has accessed the terminal device are less than a preset number of times, and whether a current date is before a preset expiration date, when determining whether the electronic device has been authorized to access the terminal device.

In the present exemplary embodiment, the determining module can determine the number of times that the electronic device has accessed the terminal device, by searching a log file. The log file can record related information of the electronic device accessing the terminal device. The related information may include, but is not limited to, a date of the electronic device accessing the terminal device, and the identification code of the electronic device.

At block 23, when the determining module determines the electronic device has been authorized to access the terminal device, a display module can display a first message of informing a user that the electronic device has been authorized to access the terminal device on a display device of the terminal device. The determining module further sends the first message to the electronic device.

At block 24, when the electronic device receives the first message, the second processor of the electronic device controls the lighting device to emit light signals representing the password of the electronic lock of the terminal device. Similarly to above, the lighting signals can be composed of one or more bright signals and one or more dark signals. The bright signal represents the numeral “1”, and the dark signal represents the numeral “0”.

At block 25, similarly to above, the collecting module can collect the light signals emitted by the lighting device using the light sensor of the terminal device. The collecting module can further convert the light signals to second digital signals. Similarly to above, the collecting module can convert the bright signal to the numeral “1”, and convert the dark signal to the numeral “0”.

At block 26, the determining module can determine whether the second digital signals matches the password of the electronic lock that is stored in the first storage device.

When the second digital signals can match the password of the electronic lock, the process goes to block 27. When the second digital signals cannot match the password of the electronic lock, the process goes to block 30.

At block 27, an unlocking module can control the electronic lock to unlock the terminal device.

In another embodiment, the unlocking module can control the electronic lock to unlock the terminal device when the first digital signals match the identification code of the electronic device, the second digital signals match the password of the electronic lock, the electronic device has accessed the terminal device for no more than a preset number of times, and the current date is before a preset expiration date.

At block 28, a display module can create the log file to record related information of the electronic device accessing the terminal device. As mentioned above, the related information may include, but is not limited to, the date of the electronic device accessing the terminal device, and the identification code of the electronic device. The display module can further store the log file in the first storage device.

At block 29, when the determining module determines the electronic device has not been authorized to access the terminal device, the display module can display a second message of informing the user that the electronic device has not been authorized to access the terminal device on the display device. The determining module further sends the second message to the electronic device.

At block 30, the display module can display a third message of informing the user that the electronic device accesses the terminal device unsuccessfully.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for controlling access to a terminal device executable by a processor of the terminal device, the terminal device comprising an electronic lock, the method comprising:
collecting light signals emitted by a lighting device of an electronic device;
converting the light signals to digital signals; and
controlling the electronic lock to unlock the terminal device when the digital signals match a preset password of the electronic lock.

2. The method according to claim 1, further comprising:
presetting the password of the electronic lock;
converting the password of the electronic lock to a two-dimensional barcode image;
receiving an input of an identification code of the electronic device; and
sending the two-dimensional barcode image to the electronic device to authorize the electronic device to access the terminal device.

3. The method according to claim 2, further comprising:
controlling the electronic lock to unlock the terminal device when the digital signals match both of the identification code of the electronic device and the password of the electronic lock.

4. The method according to claim 2, further comprising:
controlling the electronic lock to unlock the terminal device when the digital signals match both of the identification code of the electronic device and the password of the electronic lock, the electronic device has accessed the terminal device for no more than a preset number of times, and a current date is before a preset expiration date.

5. The method according to claim 1, wherein the light signals comprises at least one bright signal whose brightness value is greater than a preset value and at least one dark signal whose brightness value is less than or equal to the preset value, each of the at least one bright signal is corresponding to a numeral “1” in the digital signals, and each of the at least one dark signal is corresponding to a numeral “0” in the digital signals.

6. A terminal device, comprising:
an electronic lock;
a processor; and
a storage device that stores one or more programs, when executed by the processor, cause the processor to execute a method comprising:
collecting light signals emitted by a lighting device of an electronic device;
converting the light signals to digital signals; and
controlling the electronic lock to unlock the terminal device when the digital signals match a preset password of the electronic lock.

7. The terminal device according to claim 6, wherein the method further comprises:
presetting the password of the electronic lock;
converting the password of the electronic lock to a two-dimensional barcode image;
receiving an input of an identification code of the electronic device; and
sending the two-dimensional barcode image to the electronic device to authorize the electronic device to access the terminal device.

8. The terminal device according to claim 7, wherein the method further comprises:
controlling the electronic lock to unlock the terminal device when the digital signals match both of the identification code of the electronic device and the password of the electronic lock.

9. The terminal device according to claim 7, wherein the method further comprises:
controlling the electronic lock to unlock the terminal device when the digital signals match both of the identification code of the electronic device and the password of the electronic lock, the electronic device has accessed the terminal device for no more than a preset number of times, and a current date is before a preset expiration date.

10. The terminal device according to claim 6, wherein the light signals comprises at least one bright signal whose brightness value is greater than a preset value and at least one dark signal whose brightness value is less than or equal to the preset value, each of the at least one bright signal is corresponding to a numeral “1” in the digital signals, and each of the at least one dark signal is corresponding to a numeral “0” in the digital signals.

11. A non-transitory storage medium having stored thereon instructions that, when executed by a processor of a terminal device, causes the processor to perform a method for unlocking the terminal device, the terminal device comprising an electronic lock, wherein the method comprises:
collecting light signals emitted by a lighting device of an electronic device;
converting the light signals to digital signals; and
controlling the electronic lock to unlock the terminal device when the digital signals match a preset password of the electronic lock.

12. The non-transitory storage medium according to claim 11, the method further comprising:
presetting the password of the electronic lock;
converting the password of the electronic lock to a two-dimensional barcode image;
receiving an input of an identification code of the electronic device; and
sending the two-dimensional barcode image to the electronic device to authorize the electronic device to access the terminal device.

13. The non-transitory storage medium according to claim 12, the method further comprising:
controlling the electronic lock to unlock the terminal device when the digital signals match both of the identification code of the electronic device and the password of the electronic lock.

14. The non-transitory storage medium according to claim 12, the method further comprising:
controlling the electronic lock to unlock the terminal device when the digital signals match both of the identification code of the electronic device and the password of the electronic lock, the electronic device has accessed the terminal device for no more than a preset number of times, and a current date is before a preset expiration date.

15. The non-transitory storage medium according to claim 11, wherein the light signals comprises at least one bright signal whose brightness value is greater than a preset value and at least one dark signal whose brightness value is less than or equal to the preset value, each of the at least one bright signal is corresponding to a numeral “1” in the digital signals, and each of the at least one dark signal is corresponding to a numeral “0” in the digital signals.
